(19) United States
(12) Patent Application Publication
(10) Pub. No.: US 2002/0066881 A1
(43) Pub. Date: Jun. 6, 2002

(54) Casting or embedding compound having electromagnetic shielding properties for manufacturing electronic components

(76) Inventor: Franz Koppe, Eschenbach (DE)

Correspondence Address: KENYON & KENYON, ONE BROADWAY, NEW YORK, NY, 10004, US

(21) Appl. No.: 09/861,320

(22) Filed: May 18, 2001

(30) Foreign Application Priority Data
May 19, 2000 (DE) 100 24 439.4

(51) Int. Cl. B05D 5/12; H01F 1/00; H01F 1/26

(52) U.S. Cl. 252/62.54; 427/58; 427/128; 252/62.56

(57) ABSTRACT

A casting or embedding compound for shielding electronic components against electromagnetic radiation is formed of a polymer matrix, which includes 5 to 95 wt. % electrically non-conducting magnetic particles having a mean particle size in the range of 1 to 250 μm.

### FIELD OF THE INVENTION

The present invention relates to a casting or embedding compound having electromagnetic shielding properties for manufacturing electronic components.

### BACKGROUND INFORMATION

Electronic components such as, for example, integrated circuits (ICs), transistors, and many types of sensors are manufactured in a miniaturized form as chips and provided with a housing in which the chip is embedded and cast with a polymer resin for easier handling and to protect it from contamination and corrosive atmospheres. These casting or embedding materials have a series of characteristic properties such as, for example, reduced shrinking on setting, good heat conductivity, high electric insulation and, in some cases, a low dielectric constant. Furthermore, there are special requirements for fire resistance and melting properties of the casting compounds. In order to avoid interference due to electromagnetic fields, components having a very sensitive response to such fields or emitting electromagnetic radiation themselves are spatially separated when arranged on circuit boards or interference is suppressed by the use of additional measures such as shield plates. The trend toward miniaturization, however, increasingly limits the use of these options. Furthermore, the requirements for electromagnetic compatibility of electrical or electronic components and devices are becoming ever stricter.

U.S. Pat. No. 5,789,064 describes a material that absorbs electromagnetic radiation and is made of an electrically non-conductive body, in particular, of a polymer matrix in which fine metal particles are dispersed. This medium which absorbs electromagnetic radiation is used for lining low-reflection spaces such as those used for measuring interfering radiation and the sensitivity of devices or vehicles to interfering radiation. Due to the conductivity of the metallic particles, this electromagnetic radiation-absorbing compound cannot be directly used for casting electronic circuits.

### SUMMARY

It is an object of the present invention to provide a casting or embedding compound having electromagnetic shielding properties for manufacturing electronic components.

According to the present invention, the above and other beneficial objects are achieved by providing a casting or embedding compound for shielding electronic components against electromagnetic radiation, which is made of a polymer matrix containing 30 to 95 wt. % electrically non-conducting magnetic particles having a mean particle size in the range of 1 to 250 μm. Such a non-conducting casting or embedding compound containing electrically non-conductive particles reduces the emission of electromagnetic interfering fields from integrated circuits and increases the operational reliability of such components with respect to the electromagnetic interfering fields acting thereon. The present invention thus allows compliance with the increasingly strict legal regulations with respect to electromagnetic compatibility of electronic and high-frequency devices.

The casting compound may include soft magnetic particles, which have been found to be particularly effective.

The casting compound may include ferrite particles, which have been found to be very advantageous particularly regarding price and magnetic properties.

The polymer matrix of the casting or embedding compound according to the present invention may be made of an epoxy resin or polyester resin compound, a polyurethane, or a silicone rubber. Such polymer compounds have been found to be advantageous as casting or embedding materials and meet the requirements for such materials. Their rheological properties are not significantly modified by the addition of electrically non-conductive magnetic particles, so that they may be used in existing manufacturing facilities and processes.

The present invention furthermore relates to a method of using the casting compound, which is directly applied to the electrical and/or electronic assembly. An electrically insulating intermediary layer is not necessary. The casting compound according to the present invention may be applied to electrical and/or electronic components. In particular, for transformers, transmitters, and coils, the electromagnetic stray fields and the associated losses can thus be reduced. The casting compound according to the present invention may be used for embedding electrical and/electronic sensors.

The casting compound may be applied to the electrical and/or electronic assemblies or components as a paste, by spraying, casting or as a dipping solution. This allows a very efficient manufacturing method to be used.

The casting compound according to the present invention may be used in 0.1 to 50 mm thick layers. This allows shielding factors <75% to be achieved in the frequency range of 1000 to 5000 kHz.

### BRIEF DESCRIPTION OF THE DRAWINGS

FIG. 1 is a schematic view of a test apparatus for determining an electromagnetic shielding effect of the casting compound according to the present invention.

FIG. 2 is a graph of the shielding effect of the casting compound according to the present invention.

### DETAILED DESCRIPTION

The casting compound according to the present invention is described hereinbelow with reference to two example embodiments thereof.

### EXAMPLE 1

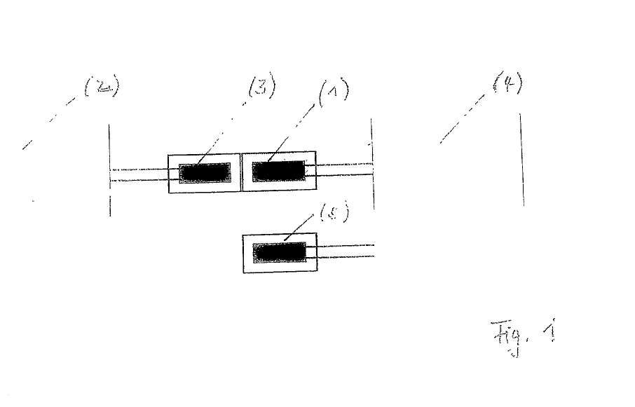

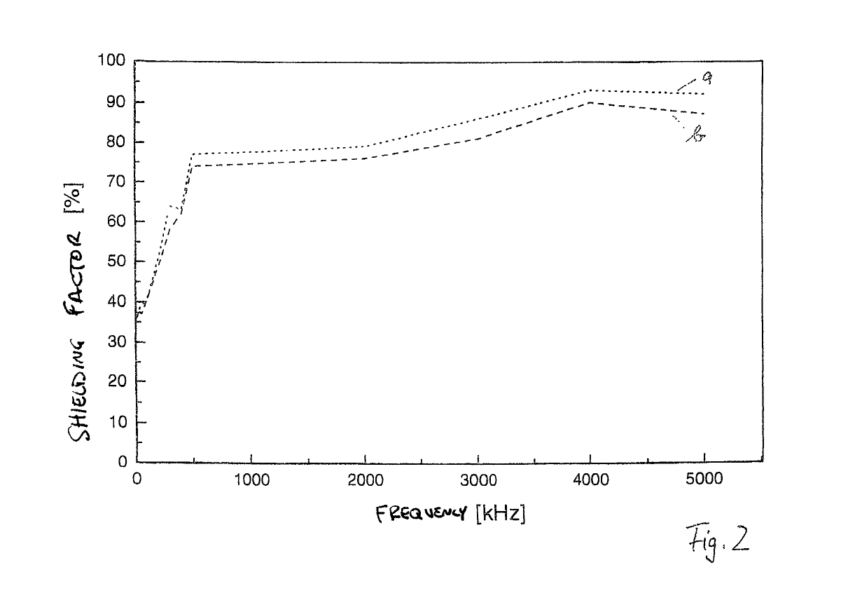

A coil was placed in a cylindrical glass container and cast using a dual-component polyurethane resin so that an approximately 5 mm thick casting compound layer surrounded the coil on all sides. The polyurethane resin compound contained 36 wt. % ferrite having a mean particle size of 1 to 50 μm. After the polyurethane resin compound had set, the coil thus shielded electromagnetically was used in the test apparatus illustrated in FIG. 1 as a receiver coil (ESM). The measuring apparatus for determining the electromagnetic shielding effect illustrated in FIG. 2 contained a high-frequency generator (2) connected to a transmitter coil (3). The transmitter coil was embedded in a cylindrical glass container of the same size as for the receiver coil (1) in a known casting compound so that it was surrounded on all sides by an approximately 5 mm thick casting compound layer. Transmitter coil (3) and receiver coil (1) were arranged base to base and the receiver coil (1) was connected to an oscilloscope (4). A receiver coil (5) similar to transmitter coil (3) was used as a reference. The electrical and mechanical properties of the transmitter (3), receiver (1), and reference coils (5) were selected to be identical within the manufacturing tolerance limits.

### EXAMPLE 2

As in Example 1, a receiving coil (1) was manufactured with the difference that ferrite particles having a mean particle size in the range of 150 to 250 μm were used.

FIG. 2 illustrates the comparison of the electromagnetic shielding effect achieved given as a shielding factor percentage with respect to the reference coil (5). Curve a was obtained with a receiver coil (1) according to Example 1 and curve b was obtained with a receiver coil (1) according to Example 2.

What is claimed is:

1. A casting compound for shielding electronic components against electromagnetic radiation, comprising:
a polymer matrix, the polymer matrix including approximately 5 to 95 wt. % electrically non-conducting magnetic particles, the particles having a mean particle size in a range of approximately 1 to 250 μm.

2. The casting compound according to claim 1, further comprising soft magnetic particles.

3. The casting compound according to claim 1, further comprising ferrite particles.

4. The casting compound according to claim 1, wherein the polymer matrix includes at least one of an epoxy resin compound, a polyester resin compound, a polyurethane and a silicone rubber.

5. A method of using a casting compound for shielding electronic components against electromagnetic radiation, the casting compound including a polymer matrix, the polymer matrix including approximately 5 to 95 wt. % electrically non-conducting magnetic particles, the particles having a mean particle size in a range of approximately 1 to 250 μm, the method comprising the step of:
applying the casting compound to at least one of an electrical assembly and an electronic assembly.

6. A method of using a casting compound for shielding electronic components against electromagnetic radiation, the casting compound including a polymer matrix, the polymer matrix including approximately 5 to 95 wt. % electrically non-conducting magnetic particles, the particles having a mean particle size in a range of approximately 1 to 250 μm, the method comprising the step of:
applying the casting compound to at least one of an electrical component and an electronic component.

7. The method according to claim 6, wherein the at least one of an electrical component and an electronic component includes at least one of an electrical sensor and an electronic sensor.

8. The method according to claim 5, wherein the applying step includes the substep of one of brushing the casting compound on the at least one of the electrical assembly and the electronic assembly, spraying the casting compound on the at least one of the electrical assembly and the electronic assembly, casting the casting compound and dipping the at least one of the electrical assembly and the electronic assembly in the casting compound.

9. The method according to claim 6, wherein the applying step includes the substep of one of brushing the casting compound on the at least one of the electrical component and the electronic component, spraying the casting compound on the at least one of the electrical component and the electronic component, casting the casting compound and dipping the at least one of the electrical component and the electronic component in the casting compound.

10. The method according to claim 5, wherein the casting compound is applied in the applying step at a thickness of 0.1 to 50 mm.

11. The method according to claim 6, wherein the casting compound is applied in the applying step at a thickness of 0.1 to 50 mm.
